(19) United States
(12) Patent Application Publication
(10) Pub. No.: US 2026/0002958 A1
(43) Pub. Date: Jan. 1, 2026

(54) DETECTION DEVICE AND DETECTION METHOD

(71) Applicant: KABUSHIKI KAISHA TOKAI RIKA DENKI SEISAKUSHO, Aichi (JP)

(72) Inventor: Masanori KOSUGI, Aichi (JP)

(73) Assignee: KABUSHIKI KAISHA TOKAI RIKA DENKI SEISAKUSHO, Aichi (JP)

(21) Appl. No.: 18/997,622

(22) PCT Filed: Jul. 24, 2023
(86) PCT No.: PCT/JP2023/027021

§ 371 Date: Jan. 22, 2025

(30) Foreign Application Priority Data
Jul. 27, 2022 (JP) 2022-119492

(51) Int. Cl. G01P 15/18; G07C 5/08

(52) U.S. Cl. CPC G01P 15/18; G07C 5/0808; G07C 5/0825

(57) ABSTRACT

A sensor device includes an acceleration sensor that detects an X-axis acceleration and a Y-axis acceleration. The sensor device further includes a signal processor that detects a fastening state of each nut based on a comparison result between a rotation angle of the sensor device calculated based on the X-axis acceleration and the Y-axis acceleration and an initial rotation angle of the sensor device calculated based on an initial value of each of the X-axis acceleration and the Y-axis acceleration. After each of the X-axis acceleration and the Y-axis acceleration becomes equal to a value that can be regarded as a zero value, the signal processor defines an acceleration which is detected by the acceleration sensor and is greater than the zero value as an initial acceleration.

### TECHNICAL FIELD

The present disclosure relates to a detection device and a detection method.

### BACKGROUND ART

Japanese Patent Laying-Open No. 2005-329907 (PTL 1) discloses a detection device that detects a mounting state of a tire (a nut for fastening a wheel rim) based on a detection value of a detector (G sensor) attached to the tire or the wheel rim.

### CITATION LIST

### Patent Literature

PTL 1: Japanese Patent Laying-Open No. 2005-329907

### SUMMARY OF INVENTION

### Technical Problem

In the detection device described in PTL 1, the looseness of a nut fastened to the wheel rim is detected based on a detection value of the G sensor. However, the vibration of the wheel rim generated when the nut is loosened may vary depending on the type of a vehicle or tire. Therefore, in order to detect the looseness of a nut (fastening member) regardless of the type of the vehicle or tire (rotating body), it is considered to detect the looseness of the nut based on an amount of change in the value based on the rotation angle of the nut. In this case, in order to detect the looseness of the nut, it is necessary to set a reference value (initial value) for the value based on the rotation angle of the nut. Therefore, it is desired to provide a detection device and a detection method that can easily set a reference value for the value based on the rotation angle of the nut (fastening member).

The present disclosure has been made to solve the aforementioned problem, and an object of the present disclosure is to provide a detection device and a detection method that can easily set a reference value for a value based on a rotation angle of a fastening member.

### Solution to Problem

A detection device according to a first aspect of the present disclosure is a detection device that detects a fastening state of a fastening member which fastens a predetermined member to a rotating body having a rotation axis which intersects with a gravitational direction, the detection device includes: a sensor unit that detects an acceleration in at least one axis along a plane which intersects with the rotation axis of the rotating body when the predetermined member is fastened to the rotating body by the fastening member; and a state detection unit that detects the fastening state of the fastening member based on a comparison result between a value based on the acceleration detected by the sensor unit and a value based on a reference acceleration defined as a reference value of the acceleration, wherein after an absolute value of the acceleration in the at least one axis becomes equal to a value that can be regarded as a zero value, the state detection unit defines a value based on the absolute value of the acceleration which is detected by the sensor unit and is greater than the zero value as the reference acceleration.

As described above, in the detection device according to the first aspect of the present disclosure, after the absolute value of the acceleration in at least one axis becomes equal to a value that can be regarded as the zero value, the acceleration which is detected by the sensor unit and is greater than the zero value is defined as the reference acceleration. In the present disclosure, in order to fasten the fastening member, the fastening member is firstly removed from the rotating body and then placed horizontally on the ground, and thereby the acceleration of the sensor unit in at least one axis becomes equal to zero. After the operation of fastening the fastening member is completed, the rotation of the rotating body is started, the fastening member is subjected to a centrifugal acceleration of a predetermined magnitude or greater. Therefore, after the operation of fastening the fastening member is completed and the rotation of the rotating body is started, the acceleration of the fastening member is automatically set as the reference acceleration. Accordingly, it is possible to reduce the time and effort of a user as compared with a case where the user sets the reference acceleration of the fastening member by performing a predetermined operation, for example. As a result, it is possible to easily set the reference acceleration for the acceleration (the value based on the rotation angle) of the fastening member.

A detection method according to a second aspect of the present disclosure is a detection method for detecting a fastening state of a fastening member which fastens a predetermined member to a rotating body having a rotation axis which intersects with a gravitational direction, the detection method includes: detecting an acceleration in at least one axis by a sensor unit that detects the acceleration in the at least one axis along a plane which intersects with the rotation axis of the rotating body when the predetermined member is fastened to the rotating body by the fastening member, after an absolute value of the acceleration in the at least one axis becomes equal to a value that can be regarded as a zero value, defining a value based on the absolute value of the acceleration which is detected by the sensor unit and is greater than the zero value as a reference acceleration; and detecting the fastening state of the fastening member based on a comparison result between a value based on the acceleration detected by the sensor unit in the at least one axis and a value based on the reference acceleration.

As described above, in the detection method according to the second aspect of the present disclosure, after the absolute value of the acceleration in at least one axis becomes equal to a value that can be regarded as the zero value, the acceleration which is detected by the sensor unit and is greater than the zero value is defined as the reference acceleration. As a result, it is possible to provide a detection method that can easily set the reference acceleration for the acceleration (the value based on the rotation angle) of the fastening member.

### Advantageous Effects of Invention

According to the present disclosure, it is possible to easily set the reference acceleration for the value based on the rotation angle of the fastening member.

### BRIEF DESCRIPTION OF DRAWINGS

FIG. 1 is a diagram illustrating a vehicle provided with a sensor device according to an embodiment.

FIG. 2 is a cross-sectional view of a nut according to the embodiment.

FIG. 3 is a diagram illustrating a configuration of a sensor device according to the embodiment.

FIG. 4 is a functional block diagram of a signal processor according to the embodiment.

FIG. 5 is a front view illustrating a configuration of a tire of a vehicle (in an initial state) according to the embodiment.

FIG. 6 is a graph illustrating a relationship between an acceleration and a rotation angle of a wheel rim when the centrifugal force is 0.

FIG. 7 is a graph illustrating a relationship between an acceleration and a rotation angle of the wheel rim when the centrifugal force is 6 G.

FIG. 8 is a front view illustrating a configuration of a tire of the vehicle (in a state where a nut is loosened) according to the embodiment.

FIG. 9 is a graph illustrating a relationship between an acceleration and a rotation angle of the wheel rim when the centrifugal force is 6 G and a nut is loosened.

FIG. 10A is a diagram illustrating a relationship between an average acceleration and a sensor angle when the centrifugal force is 6 G.

FIG. 10B is a diagram illustrating a relationship between an average acceleration and a sensor angle when the centrifugal force is 10 G.

FIG. 11 is a flowchart illustrating a method of detecting a fastening state of a nut using a sensor device according to the embodiment.

FIG. 12 is a view illustrating a state in which the sensor device according to the embodiment is placed horizontally on the ground.

FIG. 13 is a cross-sectional view of a nut according to a first modification of the embodiment.

FIG. 14 is a cross-sectional view of a nut according to a second modification of the embodiment.

### DESCRIPTION OF EMBODIMENTS

Hereinafter, an embodiment of the present disclosure will be described in detail with reference to the drawings. In the drawings, the same or corresponding parts are denoted by the same reference numerals, and the description thereof will not be repeated.

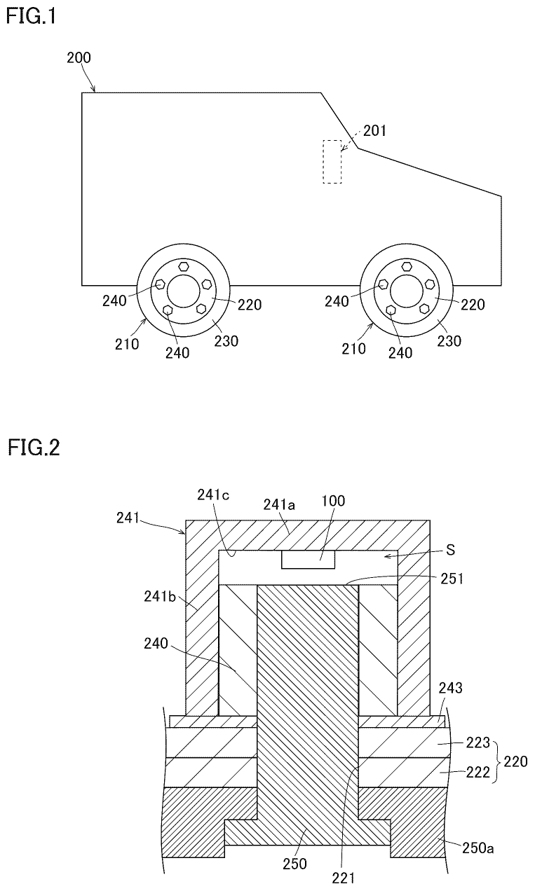

FIG. 1 is a diagram illustrating a vehicle 200 on which a sensor device 100 (see FIG. 2) according to an embodiment of the present disclosure is mounted. The vehicle 200 includes a plurality of wheels 210. The vehicle 200 further includes a communication terminal 201 that is communicable with a communication unit 3 (to be described later) and includes a display unit (not illustrated). The sensor device 100 is an example of a “detection device” in the present disclosure.

The wheel 210 includes a wheel rim 220 and a tire 230 mounted on the wheel rim 220. The wheel rim 220 is fastened to a wheel hub 250a (see FIG. 2) by a plurality of (five in FIG. 1) nuts 240. The number of nuts 240 is not limited to the number mentioned above. The wheel hub 250a is an example of a “predetermined member” and a “vehicle body” in the present disclosure. The wheel rim 220 is an example of a “rotating body” in the present disclosure, and each nut 240 is an example of a “fastening member” in the present disclosure.

As illustrated in FIG. 2, each nut 240 fastens a bolt 250 to the wheel rim 220. Specifically, the wheel rim 220 is provided with a plurality of (five) wheel holes 221, and the bolt 250 is inserted into (penetrates through) each wheel hole. Each nut 240 fastens the bolt 250 (see FIG. 2) inserted into each wheel hole 221 to the wheel rim 220. The bolt 250 is fixed to the wheel hub 250a.

FIG. 2 illustrates a double tire as an example, and the wheel rim 220 is constituted by an inner wheel rim 222 and an outer wheel rim 223.

The nut 240 is open on one side. A nut cap 241 is attached to the nut 240. The sensor device 100 may be attached to the nut cap 241, for example, and thereby is indirectly provided in the nut 240. The nut 240 is an example of a “fastening member” in the present disclosure.

Specifically, the nut cap 241 includes a top portion 241a and a side portion 241b. The side portion 241b is provided so as to circumferentially surround a portion of the bolt 250 passing through the wheel hole 221. The top portion 241a is provided to face a tip end 251 of the bolt 250 (in the insertion direction of the bolt 250). The top portion 241a is continuous with the side portion 241b. A washer 243 may be disposed between the nut 240 and the wheel rim 220.

The sensor device 100 is attached (adhered) to an inner surface 241c of the top portion 241a of the nut cap 241. Therefore, the sensor device 100 is disposed in a space S of the nut cap 241 in which the bolt 250 is accommodated.

The sensor device 100 is provided in some of the plurality of nuts 240 provided in each wheel 210. Note that the sensor device 100 may be provided in each of the plurality of nuts 240 provided in each wheel 210.

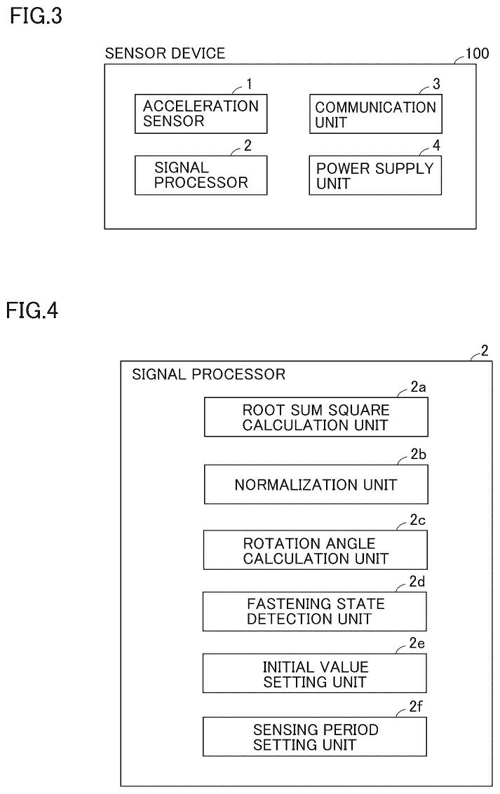

As illustrated in FIG. 3, the sensor device 100 includes an acceleration sensor 1, a signal processor 2, a communication unit 3, and a power supply unit 4. The acceleration sensor 1 is an example of a “sensor unit” in the present disclosure, and the signal processor 2 is an example of a “state detection unit”.

As illustrated in FIG. 5, the acceleration sensor 1 detects an acceleration of each of an X-axis and a Y-axis which are orthogonal to each other in a plane orthogonal to a rotation axis (not shown) of the wheel rim 220 which extends in a direction perpendicular to the paper surface of FIG. 5. The acceleration detected by the acceleration sensor 1 has a positive or negative magnitude (direction). An arrow of the X axis and an arrow of the Y axis illustrated in FIG. 5 indicate a positive direction of the X axis and a positive direction of the Y axis, respectively. When viewing from the paper surface of FIG. 5, a direction of the Y axis when it is rotated counterclockwise by 90 degrees with respect to the X axis is referred to as a positive direction.

The Z direction illustrated in FIG. 5 indicates the vertical direction (up-down direction). When the wheel 210 is rotated, a centrifugal acceleration is applied to the nut 240A in response to the rotation speed of the wheel 210. In the present embodiment, for the purpose of simplifying the description, it is assumed that the centrifugal acceleration is sufficiently larger than the gravitational acceleration (in other words, it is assumed that the gravitational acceleration may be ignored). In FIG. 5, a nut 240 of the five nuts 240 that is located at the furthest position in the Z1 direction is referred to as a nut 240A. In the following description, when the sensor device 100 is oriented as that illustrated in FIG. 5, an angle (rotation angle) of the sensor device 100 is 0 degrees.

The signal processor 2 detects a state (fastening state) of the nut 240 based on a detection signal of the acceleration sensor 1. As illustrated in FIG. 4, the signal processor 2 includes a root sum square calculation unit 2a, a normalization unit 2b, a rotation angle calculation unit 2c, a fastening state detection unit 2d, an initial value setting unit 2e, and a sensing period setting unit 2f. Note that each of the root sum square calculation unit 2a, the normalization unit 2b, the rotation angle calculation unit 2c, the fastening state detection unit 2d, the initial value setting unit 2e, and the sensing period setting unit 2f illustrated in FIG. 4 represents software in which functional features of the signal processor 2 are divided into blocks. The detail of each function will be described later.

The communication unit 3 transmits a processing result of the signal processor 2 or information based on the processing result to the communication terminal 201 (see FIG. 1) of the vehicle 200 through wireless communication.

The power supply unit 4 supplies power to each of the acceleration sensor 1, the signal processor 2 and the communication unit 3.

The acceleration sensor 1 detects an X-axis acceleration (Xg) which is an acceleration (vector) in the X axis and a Y-axis acceleration (Yg) which is an acceleration (vector) in the Y axis after the wheel hub 250a is fastened to the wheel rim 220 by the nuts 240. Each of the X-axis acceleration and the Y-axis acceleration is represented by a G value (for example, the gravitational acceleration is denoted as 1 G).

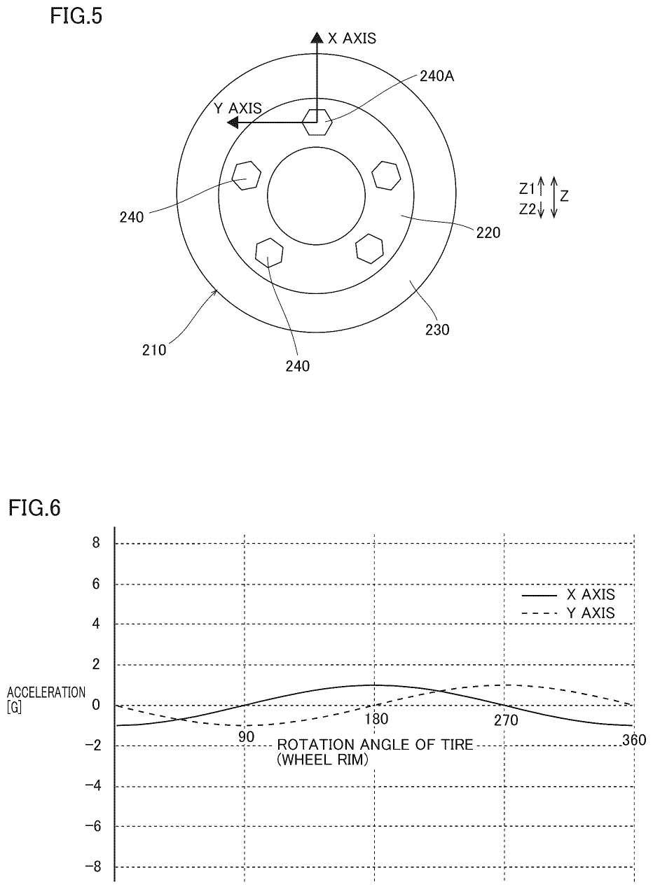

FIG. 6 is a graph illustrating a relationship between a rotation angle about the rotation axis of the tire 230 (the wheel rim 220) and each of the X-axis acceleration and the Y-axis acceleration when the vehicle speed of the vehicle 200 is zero (i.e., the centrifugal force applied to the nut 240 is zero). In this case, each of the X-axis acceleration and the Y-axis acceleration fluctuates sinusoidally in a range of ±1 G. This is because each of the X axis and the Y axis includes only an acceleration component based on the gravitational acceleration in the Z2 direction. FIG. 6 illustrates a result of the sensor device 100 provided in the nut 240A illustrated in FIG. 5.

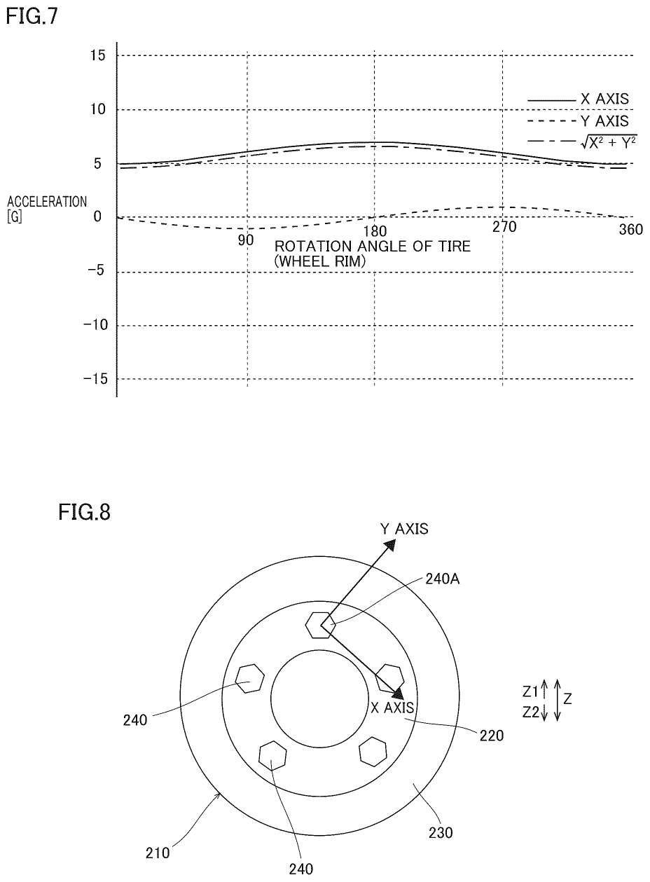

FIG. 7 is a graph illustrating a relationship between a rotation angle of the tire 230 (the wheel rim 220) and each of the X-axis acceleration and the Y-axis acceleration when the vehicle is traveling at a predetermined speed and thereby a centrifugal force with a centrifugal acceleration of 6 G is applied to the nut 240. In the present disclosure, the magnitude of the centrifugal force may be indicated by the G value. When the Y axis is oriented as that illustrated in FIG. 5, the force component of the centrifugal force is not applied to the Y axis, and thereby the Y-axis acceleration is the same as that illustrated in FIG. 6. On the other hand, since the force component of the centrifugal force is applied to the X axis, the X-axis acceleration is equal to a value obtained by adding 6 G to the X-axis acceleration illustrated in FIG. 6. In this case, the waveform of the root sum square of the X-axis acceleration and the Y-axis acceleration is the same as the waveform of the X-axis acceleration. In FIG. 7, for easy understanding, the waveform of the X-axis acceleration and the waveform of the root sum square are slightly shifted from each other. FIG. 7 also illustrates a result of the sensor device 100 provided in the nut 240A illustrated in FIG. 5.

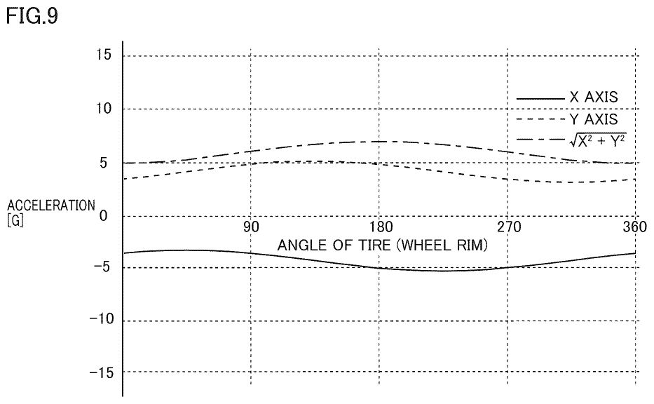

FIG. 8 is a view illustrating a state in which the nut 240 is rotated by 135 degrees in the clockwise direction (rotated by 225 degrees in the counterclockwise and loose direction) from the state illustrated in FIG. 5. FIG. 9 is a graph illustrating a relationship between an angle of the tire 230 (the wheel rim 220) and each of the X-axis acceleration and the Y-axis acceleration when a centrifugal force of 6 G is applied to the nut 240 in the state of FIG. 8. In this case, the amplitude of the waveform of each of the X-axis acceleration and the Y-axis acceleration is the same as that illustrated in FIG. 7, but each of the X-axis an average acceleration and the Y-axis average acceleration is different from that illustrated in FIG. 7. Each of the X-axis average acceleration and the Y-axis average acceleration reflects the rotation angle of the nut 240 (the sensor device 100). On the other hand, the waveform of the root sum square of the X-axis acceleration and the Y-axis acceleration is the same as that illustrated in FIG. 7, and does not change in response to the rotation angle of the nut 240 (the sensor device 100). FIG. 9 illustrates a result of the sensor device 100 provided in the nut 240A illustrated in FIG. 8.

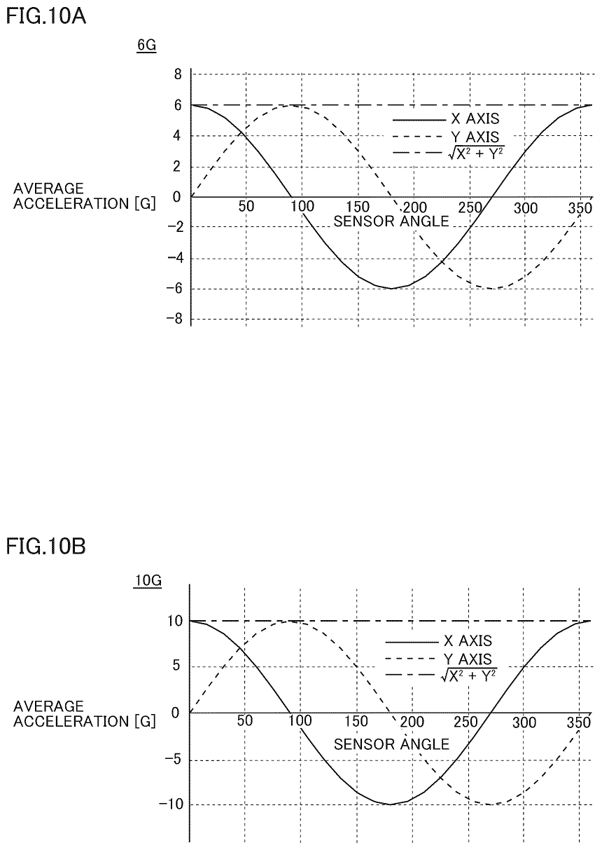

FIG. 10A is a graph illustrating an average acceleration with respect to an angle (rotation angle) of the sensor device 100 when the centrifugal force is 6 G. FIG. 10B is a graph illustrating an average acceleration with respect to an angle (rotation angle) of the sensor device 100 when the centrifugal force is 10 G. As illustrated in FIGS. 10A and 10B, the waveform of each of the X-axis average acceleration and the Y-axis average acceleration has an amplitude corresponding to the centrifugal force (the scales of the vertical axes are different from each other), but has the same shape as each other. In each of FIGS. 10A and 10B, the root sum square of the X-axis average acceleration and the Y-axis average acceleration is a constant value corresponding to the centrifugal force. Therefore, a value obtained by dividing the X-axis average acceleration by the root sum square and a value obtained by dividing the Y-axis average acceleration by the root sum square becomes equal to each other regardless of the magnitude of the centrifugal force.

In the present embodiment, the signal processor 2 (the root sum square calculation unit 2a) calculates the root sum square of the X-axis acceleration (Xg) and the Y-axis acceleration (Yg). The signal processor 2 (the normalization unit 2b) calculates an X-axis normalized value by dividing the X-axis acceleration by the root sum square. The signal processor 2 (the normalization unit 2b) calculates a Y-axis normalized value by dividing the Y-axis acceleration by the root sum square.

Then, the signal processor 2 (the rotation angle calculation unit 2c) calculates a rotation angle of the nut 240 (the sensor device 100) based on both the X-axis normalized value and the Y-axis normalized value. As described above with reference to FIGS. 10A and 10B, when the vehicle speed is equal to or greater than a predetermined value, the X-axis normalized value and the Y-axis normalized value depend on the sensor angle regardless of the centrifugal force (the vehicle speed). Therefore, by using the X-axis normalized value and the Y-axis normalized value, it is possible to determine the rotation angle of the nut 240 regardless of the vehicle speed. The signal processor 2 (the rotation angle calculation unit 2c) acquires information on the X-axis acceleration and the Y-axis acceleration from the acceleration sensor 1 and calculates the rotation angle of the nut 240 every predetermined period (for example, every 20 seconds to 120 seconds). The rotation angle of the nut 240 is an example of a “value based on the acceleration” in the present disclosure.

The signal processor 2 (the fastening state detection unit 2d) detects the fastening state of the nut 240 based on a difference between a rotation angle of the nut 240 calculated at the current time and a previous rotation angle of the nut 240. If the difference is beyond a predetermined allowable range, the signal processor 2 (the fastening state detection unit 2d) determines that the nut 240 is loosened (not fastened). In this case, the signal processor 2 notifies the communication terminal 201 (see FIG. 1) that the nut 240 is loosened through the communication unit 3 (see FIG. 3). This may cause the communication terminal 201 to display a warning on a display unit (not shown), or may cause the communication terminal 201 to issue a warning sound. On the other hand, if the difference is within the predetermined allowable range, the signal processor 2 (the fastening state detection unit 2d) determines that the nut 240 is fastened. In this case, the signal processor 2 does not notify the communication terminal 201. The previous rotation angle may be a rotation angle of a previous time, or may be an average value of rotation angles for several previous times including the previous time.

The signal processor 2 (the fastening state detection unit 2d) determines that the rotation of the wheel rim 220 (the tire 230) is stopped when each of the current detection value and the previous detection value which has a larger absolute value of the X-axis acceleration and the Y-axis acceleration detected by the acceleration sensor 1 is within a range of ±1 G. The previous detection value may be a detection value of a previous time, or may be an average value of detection values for several previous times including the previous time. It is possible to determine that the rotation of the wheel rim 220 (the tire 230) is stopped based on either the X-axis acceleration or the Y-axis acceleration. It is possible to determine that the rotation of the wheel rim 220 (the tire 230) is stopped when the current detection value of both the X-axis acceleration and the Y-axis acceleration and the previous detection value of both the X-axis acceleration and the Y-axis acceleration are both within the range of ±1 G.

When it is determined that the rotation of the wheel rim 220 (the tire 230) is stopped, the signal processor 2 increases a sensing period (the predetermined period) of the sensor device 100 (for example, increases the sensing period to 30 minutes).

The signal processor 2 acquires information on each of the X-axis acceleration and the Y-axis acceleration detected by the acceleration sensor 1. After each of the X-axis acceleration and the Y-axis acceleration becomes equal to a value that can be regarded as a zero value, the signal processor 2 (the initial value setting unit 2e) defines each of the X-axis acceleration and the Y-axis acceleration as an initial value when at least a larger absolute value of the X-axis acceleration and the Y-axis acceleration becomes equal to or greater than a predetermined value (for example, 2 G) which is greater than the zero value. The initial value is an example of a “reference acceleration” in the present disclosure. The value that can be regarded as the zero value refers to such a value that is within a predetermined range centered on the zero value (for example, 0±0.1 G).

For example, when using a torque wrench to tighten the nut 240, the nut 240 is firstly removed from the wheel rim 220 and then placed horizontally on the ground, and thereby each of the X-axis acceleration and the Y-axis acceleration will be zero. After the nut 240 is attached to the wheel rim 220, the vehicle 200 travels at a predetermined speed or more, and thereby a centrifugal acceleration of 3 G or more is applied to the nut 240. At this time, each of the X-axis acceleration and the Y-axis acceleration is set as the initial value.

Specifically, after the state in which each of the X-axis acceleration and the Y-axis acceleration can be regarded as a zero value continues for a predetermined period or longer (for example, 30 minutes or longer), the signal processor 2 (the initial value setting unit 2e) sets each of the X-axis acceleration and the Y-axis acceleration as an initial value when at least a larger absolute value of the X-axis acceleration and the Y-axis acceleration becomes equal to or greater than the predetermined value. Thus, it is possible to prevent the initial value from being set when each of the X-axis acceleration and the Y-axis acceleration becomes equal to zero (instantaneously) due to a false detection of the acceleration sensor 1.

Specifically, in a plurality of detections after each of the X-axis acceleration and the Y-axis acceleration becomes equal to zero, when at least a larger absolute value of the X-axis acceleration and the Y-axis acceleration becomes equal to or greater than the predetermined value, each of an average value of the X-axis accelerations obtained in the plurality of detections and an average value of the Y-axis accelerations obtained in the plurality of detections is set as the initial value. The plurality of detections may be a plurality of continuous detections.

The signal processor 2 (the sensing period setting unit 2f) increases the sensing period after each of the X-axis acceleration and the Y-axis acceleration becomes equal to zero. For example, the signal processor 2 changes the sensing period from 20 to 120 seconds to 30 minutes (constant value).

The signal processor 2 (the fastening state detection unit 2d) detects the fastening state of the nut 240 based on a difference between a current rotation angle of the nut 240 (the sensor device 100) and a rotation angle of the nut 240 (the sensor device 100) calculated based on the initial value. Specifically, the signal processor 2 (the fastening state detection unit 2d) determines that the nut 240 is loosened (not fastened) when the difference is beyond the predetermined allowable range. In this case, the signal processor 2 notifies the communication terminal 201 (see FIG. 1) that the nut 240 is loosened through the communication unit 3 (see FIG. 3). This may cause the communication terminal 201 to display a warning on a display unit (not shown), or may cause the communication terminal 201 to issue a warning sound.

### Method for Detecting Fastening State of Nut

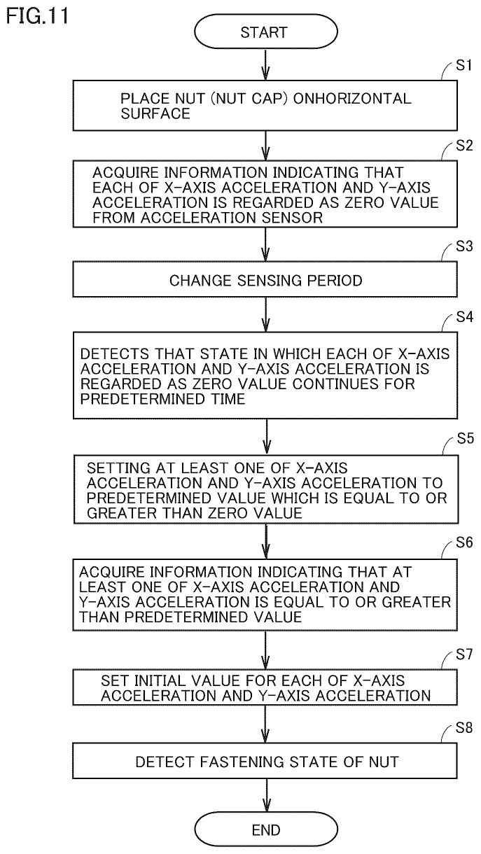

Next, a method of detecting the fastening state of a nut 240 will be described with reference to the flowchart of FIG. 11.

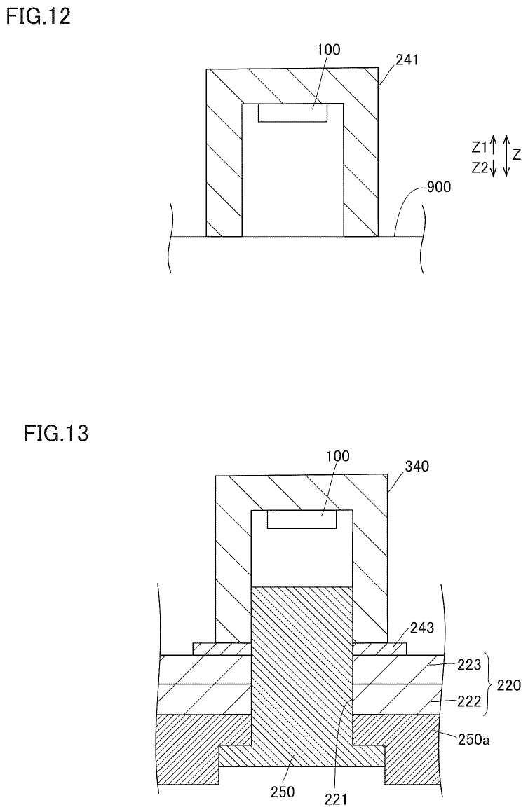

First, in step S1, a step of placing a nut 240 (a nut cap 241) on a horizontal surface 900 perpendicular to the vertical direction (see FIG. 12) is performed. Thus, each of the X-axis acceleration and the Y-axis acceleration detected by the acceleration sensor 1 becomes equal to zero. Next, in step S2, the signal processor 2 acquires information indicating that each of the X-axis acceleration and the Y-axis acceleration is zero (or can be regarded as a zero value) from the acceleration sensor 1. Next, in step S3, the signal processor 2 (the sensing period setting unit 2f) changes the sensing period from 20 to 120 seconds to 30 minutes, for example.

Next, in step S4, the signal processor 2 determines that the state in which each of the X-axis acceleration and the Y-axis acceleration is zero continues for a predetermined period (for example, 30 minutes) or more based on the information from the acceleration sensor 1.

Thereafter, in step S5, after the wheel hub 250a is fastened to the wheel rim 220 by the nuts 240, at least one of the X-axis acceleration and the Y-axis acceleration is set to the predetermined value (for example, 2 G) or more. Specifically, after the wheel hub 250a is fastened to the wheel rim 220 by the nuts 240, the vehicle 200 travels at a predetermined speed or more, and thereby a centrifugal acceleration of a predetermined magnitude or greater is applied to the nut 240.

Next, in step S6, the signal processor 2 acquires information indicating that at least one of the X-axis acceleration and the Y-axis acceleration is equal to or greater than the predetermined value.

Next, in step S7, the signal processor 2 (initial value setting unit 2e) sets each of the X-axis acceleration and the Y-axis acceleration as an initial value when it is determined that at least one of the X-axis acceleration and the Y-axis acceleration is equal to or greater than the predetermined value (when the information is acquired in step S6). Specifically, the signal processor 2 (the initial value setting unit 2e) sets, as the initial value, an average value of the X-axis accelerations or the Y-axis accelerations detected in a plurality of times (for example, three times) after the information is acquired in step S6.

In step S8, the signal processor 2 (the fastening state detection unit 2d) detects the fastening state of the nut 240 based on the initial value of each of the X-axis acceleration and the Y-axis acceleration set in step S7. Specifically, the signal processor 2 (the fastening state detection unit 2d) detects the looseness of the nut 240 based on a difference between a rotation angle of the nut 240 calculated based on the current X-axis acceleration and the current Y-axis acceleration and a rotation angle of the nut 240 calculated based on the initial value.

The steps S1 and S5 are performed by a user, and the other steps are performed by the signal processor 2.

As described above, in the present embodiment, after each of the X-axis acceleration and the Y-axis acceleration becomes equal to a value that can be regarded as the zero value, each of the X-axis acceleration and the Y-axis acceleration is set as an initial value when at least a larger absolute value of the X-axis acceleration and the Y-axis acceleration becomes equal to or greater than a predetermined value which is greater than the zero value. Since the initial value is automatically set for the X-axis acceleration and the Y-axis acceleration, it is possible to reduce the time and effort of the user. As a result, it is possible to easily set the initial value for the X-axis acceleration and the Y-axis acceleration.

Since there is no need to provide a mechanical switch or the like for registering the initial value, it is possible to reduce the number of components in the vehicle 200, which makes it possible to simplify the configuration of the vehicle 200. In addition, it is also acceptable to provide a mechanical switch as described above or a switch that is switched on and off by magnetic force in the vehicle to register the initial value.

In the present embodiment, it is described that the signal processor 2 sets the sensing period to 30 minutes (constant value) after each of the X-axis acceleration and the Y-axis acceleration becomes equal to a value that can be regarded as a zero value, but the present disclosure is not limited thereto. The signal processor 2 may gradually increase the sensing period after each of the X-axis acceleration and the Y-axis acceleration becomes equal to a value that can be regarded as a zero value. For example, the signal processor 2 may gradually increase the sensing period to 1 minute, 5 minutes, 30 minutes, 2 hours, or 6 hours (hereinafter, every 6 hours). In the present embodiment, it is described that the initial value is set after the state in which each of the X-axis acceleration and the Y-axis acceleration can be regarded as the zero value continues for 30 minutes or longer, for example, but the present disclosure is not limited thereto, and the initial value may be set after the state continues for 5 minutes or longer.

In the present embodiment, it is described that the acceleration sensor 1 detects the X-axis acceleration and the Y-axis acceleration, but the present disclosure is not limited thereto. For example, the acceleration sensor may detect accelerations in three or more axes that intersect with each other in a plane orthogonal to the rotation axis of the wheel rim 220. The acceleration sensor may detect only one of the X-axis acceleration and the Y-axis acceleration.

In the present embodiment, it is described that the average value of the X-axis accelerations or the Y-axis accelerations in a plurality of detections is set as the initial value after each of the X-axis acceleration and the Y-axis acceleration becomes equal to zero, but the present disclosure is not limited thereto. The X-axis acceleration or the Y-axis acceleration calculated in one sensing may be set as the initial value after each of the X-axis acceleration and the Y-axis acceleration becomes equal to zero.

In the present embodiment, it is described that the fastening state of the nut 240 provided on the wheel rim 220 of the vehicle 200 is detected, but the present disclosure is not limited thereto. For example, the fastening state of a fastening member such as a nut attached to an elevator pulley, a belt conveyor pulley, a coffee cup and a merry-go-round provided in an amusement park, or a rotating toy provided in a park may be detected. In the examples mentioned above, in the case of the rotating body rotating along a plane perpendicular to the gravitational direction, since the centrifugal force is not affected by the gravitational force, it is possible to easily detect the fastening state of the fastening member even when the centrifugal acceleration is small. In a case where a rotating body rotates along a plane perpendicular to the gravitational direction, the X-axis acceleration (Y-axis acceleration) becomes equal to zero when the rotation of the rotating body is stopped. In this case, the reset condition (the condition corresponding to step S2) is always satisfied when the rotation of the rotating body is stopped. Therefore, in this modification, it is preferable to interchange the reset condition and the initial value setting condition (the condition corresponding to step S6).

In the present embodiment, it is described that the nut cap 241 is attached to the nut 240, but the present disclosure is not limited thereto. As illustrated in FIG. 13, the sensor device 100 may be attached to a nut 340 that is a cap nut. The nut 340 is an example of a “fastening member” in the present disclosure.

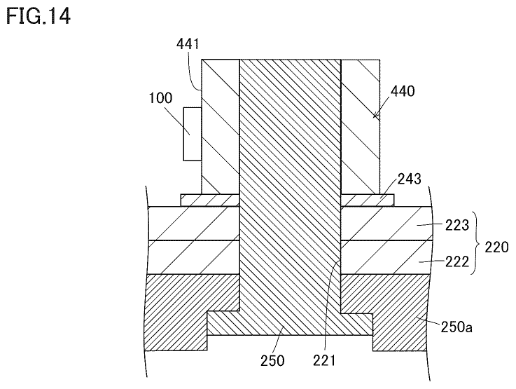

In a second modification illustrated in FIG. 14, a nut 440 is open on one side and does not include a nut cap. In the second modification, the sensor device 100 may be provided on a side surface 441 of the nut 440 (a surface that is orthogonal to the wheel rim 220). The nut 440 is an example of a “fastening member” in the present disclosure.

In the present embodiment, it is described that the sensor device 100 is provided in the nut 240, but the present disclosure is not limited thereto. The sensor device 100 may be provided in a bolt (a bolt that is separate from the wheel hub). In this case, the bolt is an example of a “fastening member” in the present disclosure.

In the present embodiment, it is described that the looseness of the nut 240 is detected by the signal processor 2 provided in the sensor device 100, but the present disclosure is not limited thereto. For example, the detection value of the acceleration sensor 1 may be transmitted to an electronic control unit (ECU) provided in the vehicle 200 through the communication unit 3, and the ECU may detect the looseness of the nut 240 based on the detection value.

In the present embodiment, it is described that the fastening state (the looseness) of the nut 240 is detected based on a change in the rotation angle of the nut 240, but the present disclosure is not limited thereto. The fastening state (the looseness) of the nut 240 may be detected by comparing an amount of change in at least one of the X-axis normalized value (X-axis acceleration) and the Y-axis normalized value (Y-axis acceleration) with a predetermined threshold value. In this case, the X-axis normalized value (X-axis acceleration) and the Y-axis normalized value (Y-axis acceleration) are examples of a “value based on the acceleration” in the present disclosure.

In the present embodiment, it is described that the initial value is set when each of the X-axis acceleration and the Y-axis acceleration becomes equal to a value that can be regarded as a zero value, but the present disclosure is not limited thereto. The initial value may be set when either one of the X-axis acceleration and the Y-axis acceleration becomes equal to a value that can be regarded as a zero value. Further, instead of detecting that each of the X-axis acceleration and the Y-axis acceleration becomes equal to a value that can be regarded as a zero value, the initial value may be set by detecting that the acceleration in the direction of Z-axis which is parallel to the gravitational direction has reached 1 G. Alternatively, the initial value may be set after the composite vector of the X-axis acceleration, the Y-axis acceleration and the Z-axis acceleration becomes equal to 1 G in the direction of gravitational acceleration.

In the present embodiment, it is described that the initial value is set for the X-axis acceleration (Y-axis acceleration), but the present disclosure is not limited thereto. The initial value may also be set for the rotation angle of the nut 240 calculated from the X-axis acceleration (Y-axis acceleration).

In the present embodiment, it is described that the X axis and the Y axis are orthogonal to each other, but the present disclosure is not limited thereto. The X axis and the Y axis may not be orthogonal to each other, and may intersect with each other.

In the present embodiment, it is described that the plane in which the X axis and the Y axis are provided is orthogonal to the rotation axis of the wheel rim 220, but the present disclosure is not limited thereto. The plane may not be orthogonal to the rotation axis, and may intersect with the rotation axis.

In the present embodiment, it is described that the fastening state of the nut 240 is detected using the X-axis normalized value and the Y-axis normalized value, but the present disclosure is not limited thereto. When the X-axis and the Y-axis are orthogonal to each other, the fastening state of the nut 240 may be detected using an inverse trigonometric function of the X-axis acceleration and the Y-axis acceleration. The inverse trigonometric function includes an arctangent function (arctan), an arcsine function (arcsin), an arccosine function (arccos), an arccotangent function (arccot), an arccosecant function (arccsc), and an arcsecant function (arcsec). Further, the fastening state of the nut 240 may be detected based on a ratio between the X-axis acceleration and the Y-axis acceleration.

In the above embodiment, the number of the sensor devices 100 for one wheel rim 220 may be appropriately changed as long as the number is one or more.

The above-mentioned embodiments and the above-mentioned modifications may be appropriately combined as long as there is no technical inconsistency.

It should be understood that the embodiments disclosed herein are illustrative and non-restrictive in all respects. The scope of the present disclosure is defined not by the above description but by the claims, and is intended to include all modifications within the meaning and scope equivalent to the claims.

### REFERENCE SIGNS LIST

1: acceleration sensor (sensor unit); 2: signal processor (state detection unit); 100: sensor device (detection device); 220: wheel rim (rotating body); 240, 340, 440: nut (fastening member); 250a: wheel hub (predetermined member) (vehicle body).

1. A detection device that detects a fastening state of a fastening member which fastens a predetermined member to a rotating body having a rotation axis which intersects with a gravitational direction, the detection device comprising:
a sensor unit that detects an acceleration in at least one axis along a plane which intersects with the rotation axis of the rotating body when the predetermined member is fastened to the rotating body by the fastening member; and
a state detection unit that detects the fastening state of the fastening member based on a comparison result between a value based on the acceleration detected by the sensor unit and a value based on a reference acceleration defined as a reference value of the acceleration,
wherein after an absolute value of the acceleration in the at least one axis becomes equal to a value that can be regarded as a zero value, the state detection unit defines a value based on the absolute value of the acceleration which is detected by the sensor unit and is greater than the zero value as the reference acceleration.

2. The detection device according to claim 1, wherein
the state detection unit acquires the acceleration in the at least one axis of the fastening member in each predetermined period, and
after the absolute value of the acceleration in the at least one axis becomes equal to a value that can be regarded as the zero value, the state detection unit defines an average value of values based on absolute values of accelerations which are detected by the sensor unit for a plurality of times and are greater than the zero value as the reference acceleration.

3. The detection device according to claim 1, wherein
the state detection unit acquires the acceleration in the at least one axis of the fastening member in each predetermined period, and
after the absolute value of the acceleration in the at least one axis becomes equal to a value that can be regarded as the zero value, the state detection unit increases the predetermined period.

4. The detection device according to claim 3, wherein
after the absolute value of the acceleration in the at least one axis becomes equal to a value that can be regarded as the zero value, the state detection unit gradually increases the predetermined period.

5. The detection device according to claim 1, wherein
the sensor unit is provided in a nut that fixes a wheel rim to a vehicle body.

6. The detection device according to claim 1, wherein
the at least one axis includes a first axis and a second axis intersecting with each other,
after an absolute value of the acceleration in each of the first axis and the second axis becomes equal to a value that can be regarded as the zero value, the state detection unit defines each of the acceleration in the first axis and the acceleration in the second axis as the reference acceleration when the absolute value of the acceleration in at least one of the first axis and the second axis becomes equal to or greater than a predetermined value which is greater than the zero value.

7. A detection method for detecting a fastening state of a fastening member which fastens a predetermined member to a rotating body having a rotation axis which intersects with a gravitational direction, the detection method comprising:
detecting an acceleration in at least one axis by a sensor unit that detects the acceleration in the at least one axis along a plane which intersects with the rotation axis of the rotating body when the predetermined member is fastened to the rotating body by the fastening member;
after an absolute value of the acceleration in the at least one axis becomes equal to a value that can be regarded as a zero value, defining a value based on the absolute value of the acceleration which is detected by the sensor unit and is greater than the zero value as a reference acceleration; and
detecting the fastening state of the fastening member based on a comparison result between a value based on the acceleration detected by the sensor unit in the at least one axis and a value based on the reference acceleration.
